(19) United States
(12) Patent Application Publication
(10) Pub. No.: US 2003/0016092 A1
(43) Pub. Date: Jan. 23, 2003

(54) RF termination device

(76) Inventors: William J. Palmteer, North Andover, MA (US); Robert L. Severance, Natick, MA (US); Ernest H. Hoagland, Waltham, MA (US)

Correspondence Address: Joeseph A. Tessari, Esquire, The Whitaker Corporation, Suite 450, 4550 New Linden Hill Road, Wilmington, DE, 19808-2952, US

(21) Appl. No.: 09/910,374

(22) Filed: Jul. 20, 2001

(51) Int. Cl. H01P 1/26

(52) U.S. Cl. 333/22 R; 333/81 A

(57) ABSTRACT

An improved RF termination and a method of providing the RF termination are disclosed. The RF termination for terminating an open RF signal from an open RF signal source, includes a hollow shell, and an axial resistor inserted within the hollow shell, wherein the axial resistor includes a first lead connectable to the open RF signal source and a second lead being grounded by the hollow shell.

### FIELD OF THE INVENTION

The present invention relates to RF (Radio Frequency) terminations and, more particularly, to an improved RF termination which is easy to assemble and cost effective to manufacture.

### BACKGROUND OF THE INVENTION

Radio Frequency (RF) terminations are devices used to ground or electrically “terminate” open RF signal sources such as RF ports found in common electronic devices such as cellular base stations and RF test equipment. For example, when certain RF ports of an electronic device are not being used, 50 ohm RF terminations are typically used to ground these ports. The RF termination prevents any unwanted and wasteful dissipation of RF signals from the open RF signal source. Furthermore, the RF termination prevents signal interferences with other RF signals which may occur due to the leakage of RF signals through the open RF signal source.

FIG. 1 is a sectional view of a conventional 50 ohm RF termination 10 to be used with a conventional female SMA connector 30. As shown in FIG. 1, the 50 ohm RF termination 10 is typically screwed onto the female connector 30 which is connected to an open RF signal source (not shown) such as a port of an electronic device. The 50 ohm RF termination 10 includes a metal plug body 11 screwed in a coupling nut 12. A gasket 20 and a retaining ring 22 are used to securely position the plug body 11 in the coupling nut 12. A male contact pin 14 and a dielectric member 13 are fixedly provided inside the plug body 11. A 50 ohm resistor 16 is soldered to one end of the male contact pin 14 and to the inner surface of the plug body 11 by solder paste 18. The 50 ohm resistor 16 is a ceramic thin film having resistive paste and does not have any leads. All these components are assembled together to produce the conventional 50 ohm RF termination 10.

When the RF termination 10 is screwed onto the female connector 30, the female connector 30 is disposed inside the RF termination 10 and the male contact pin 14 will be disposed in a hole 32 of the connector 30. Through the hole 32, the pointing end of the male contact pin 14 will contact electrically the open RF signal source disposed on the other side of the female connector 30. Since one end of the male contact pin 14 is electrically connected to the open RF signal source and the other end of the male contact pin 14 is grounded through the resistor 16 soldered to the plug body 11, the open RF signal source is grounded, thereby effectively terminating the open RF signal source.

Although the conventional RF termination is effective, it does suffer from certain disadvantages. For example, the ceramic-type resistor is expensive, resulting in an expensive RF termination. Furthermore, since the ceramic-type resistor is manufactured without any contact leads, the RF termination 10 requires multiple components that must be assembled together to function as the contact leads and housing for the ceramic-type resistor. This complicates the assembly process and increases the manufacturing cost. Moreover, in lieu of the female SMA connector 30, if a different type of a connector, such as a BNC or Type-N connecter, were to be used, then many different components of the RF Termination 10 need to be modified to adapt to the new connector. This can restrict the applicability of conventional RF terminations.

Accordingly, a need exists for an improved RF termination which is easy to assemble, inexpensive to manufacture and easily adaptable for different applications.

### SUMMARY OF THE INVENTION

The present invention is directed to an improved RF termination which overcomes drawbacks associated with conventional RF terminations. Specifically, rather than a ceramic-type resistor, the present invention uses an axial-type resistor which is a widely-available resistor having a resistive element and two contact leads extending directly from the resistive element in the opposite directions.

The use of an axial resistor rather than a ceramic-type resistor offers a number of advantages over prior art designs. First, the axial resistor is widely available and significantly less expensive than the ceramic-type resistor used in prior art RF terminations. Consequently, the component costs of the RF termination device of the present invention are significantly less than those of conventional devices. Furthermore, the present invention reduces the number of component parts required by exploiting the lead contacts that extend from either end of the axial resistor. Specifically, rather than incorporating additional components in the RF termination device to effect the electrical connections between the resistor and the RF source and between the resistor and ground as is done in the prior art, the RF termination device of the present invention preferably uses one contact lead of the resistor to connect directly with the RF source and the other contact lead to connect directly to the ground. Aside from the obvious savings in both material and manufacturing costs, a reduction in the number of parts to be assembled also improves the adaptability and applicability of the RF termination in accommodating different connectors as needed by different systems. Additionally, the reduction in parts and complexity generally tends to increase reliability. Thus, overall, the present invention provides an improved RF termination which is easy to assemble, cost effective to manufacture, easily adaptable, reliable and refined in appearance.

In one embodiment, the RF termination of the present invention includes a metal hollow shell and an axial resistor. One lead of the axial resistor is electrically connected to the hollow shell, and the other lead is exposed and positioned such that, when the RF termination is engaged with a connector of a communication device having an open RF signal source, the exposed lead of the axial resistor electrically connects to the open RF signal source through the connector. Since one lead of the axial resistor is electrically connected to the open RF signal source and the other lead of the axial resistor is electrically connected to the hollow shell which in turn is grounded through known grounding techniques, the open RF signal source is grounded by the operation of the RF termination.

In another embodiment, the present invention is directed to a method of producing a signal termination device for terminating an open RF signal from a communication component containing an open RF signal source. The method comprises the steps of: providing a hollow shell and an axial resistor having first and second leads; and assembling the axial resistor within the hollow shell, wherein the first lead of the axial resistor is electrically connectable to the open RF signal source and the second lead of the axial resistor is grounded by the hollow shell.

In yet another embodiment, the present invention is directed to a method of terminating an open RF signal source using an RF termination device. The method comprises the steps of: providing the RF termination device including a hollow shell and an axial resistor inserted within the hollow shell, the axial resistor including a first lead connectable to the open RF signal source and a second lead being grounded by the hollow shell; and engaging a connector of the open RF signal source with the RF termination device to terminate the open RF signal source.

In still another embodiment, the present invention is directed to a communication component which incorporates an RF termination device. The communication component comprises: an RF signal source; a connector coupled with the RF signal source; and an RF termination device comprising at least: a hollow shell coupled with the connector and being grounded; and an axial resistor inserted within the hollow shell and including a first lead electrically connect to the RF signal source and a second lead electrically connected to the hollow shell.

### BRIEF DESCRIPTION OF THE DRAWINGS

In the drawings, the same reference numerals are used to indicate the same elements.

FIG. 1 is a sectional view of a conventional 50 ohm RF termination connectable to a conventional female SMA connector.

FIGS. 2A-2C are different views of the components of a RF termination according to one embodiment of the present invention.

FIG. 3 is a sectional view of the RF termination of FIG. 2C connectable to a conventional female SMA connector according to one embodiment of the present invention.

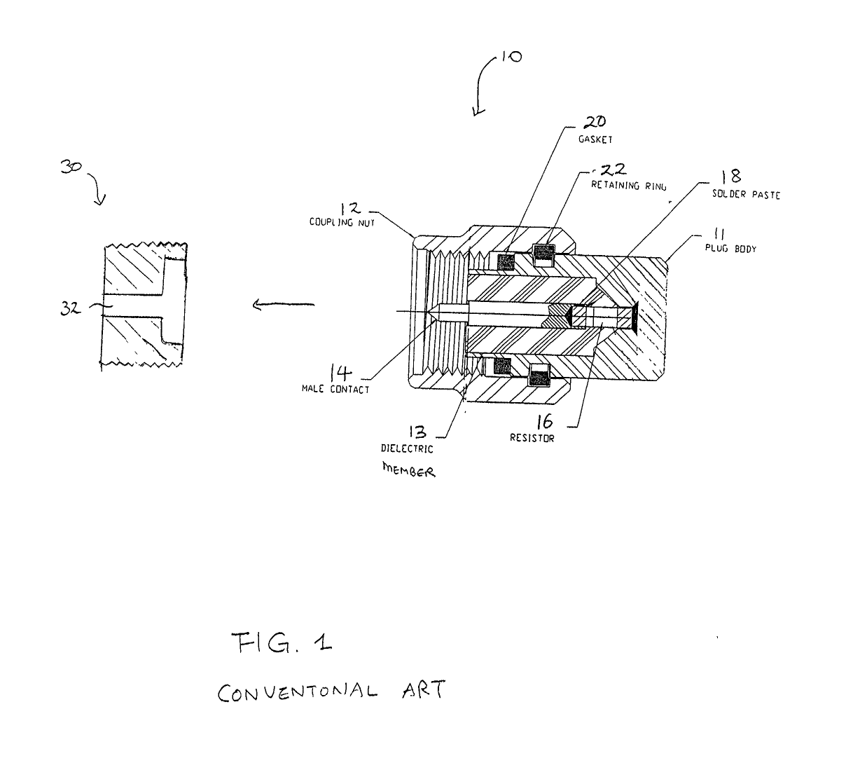

### DETAILED DESCRIPTION OF THE PREFERRED EMBODIMENTS

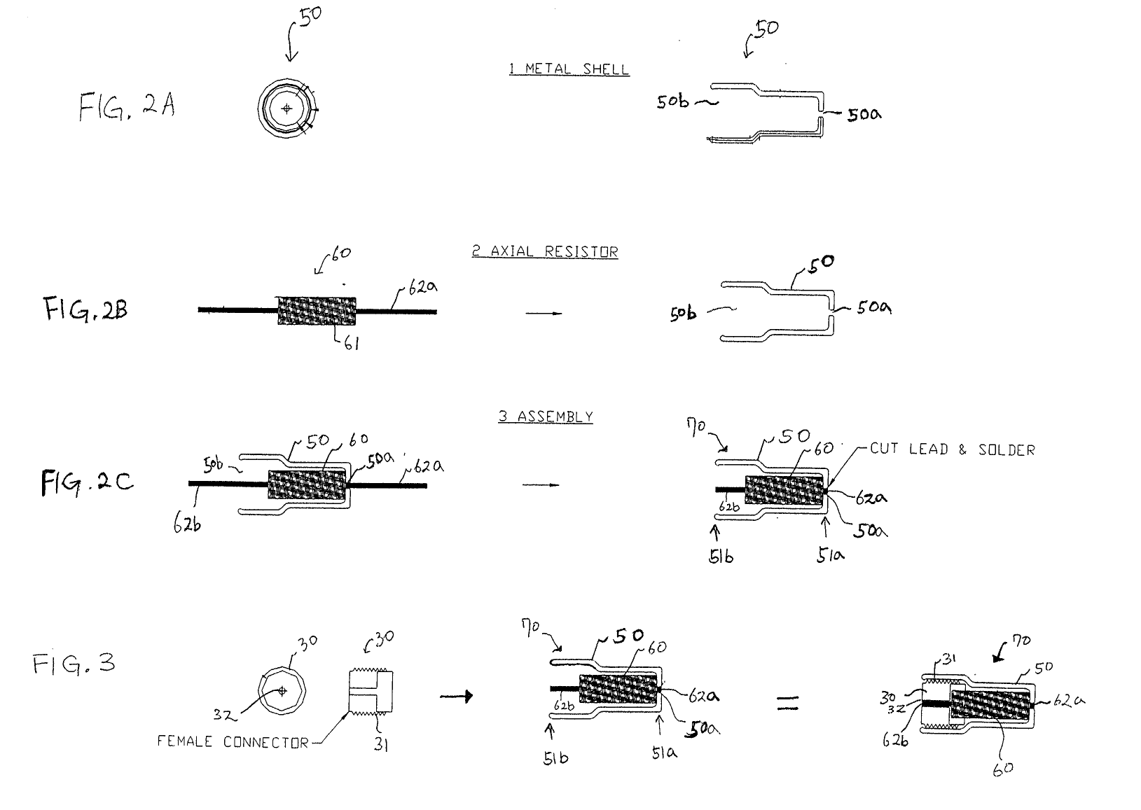

FIGS. 2A-2C are sectional views of the components of a RF termination 70 according to one embodiment of the present invention. Referring to FIGS. 2A-2C, the RF termination 70 of the present invention comprises two main components: a metal shell 50 and an axial resistor 60 contained in the metal shell 50. The metal shell 50 is a hollow housing made with a conductive material such as aluminum. The metal shell 50 includes a hole 50a on one end thereof and an opening 50b on the opposite end thereof. The metal shell 50 has a cylindrical configuration with a conically tapering portion and can be formed using any known techniques. For example, a deep drawn process or a molding process well known in the art can be used to form the metal shell 50.

Once the metal shell 50 is formed, the metal shell 50 is assembled with the axial resistor 60. The axial resistor 60, as shown in FIG. 2B, is a conventional axial resistor that is widely available in the market at a minimum cost. As known, the axial resistor 60 includes a resistive element 61 and first and second contact leads 62a, 62b extending from the opposite ends of the resistive element 61. Although the preferred resistance of the resistive element 61 is 50 ohm, any resistance value, e.g., 75 ohm, can be used depending on the application.

The axial resistor 60 is inserted through the metal shell 50 such that the first lead 62a projects from the hole 50a of the metal shell 50 and the second lead 62b projects from the opening 50b of the metal shell 50 as shown in FIG. 2C. Once the axial resistor 60 is fit within the metal shell 50, the first lead 62a is trimmed flush with the outer surface of the one end 51a of the metal shell 50 and the remaining first lead 62a is fixedly positioned within the hole 50a, e.g., using solder paste. Similarly, second lead 62b is trimmed so that the remaining second lead 62b is aligned or flush with the other end 51b of the metal shell 50. This completes the formation of the RF termination 70 according to one embodiment of the present invention.

Depending on the application, in some cases, the second lead 62b of the axial resistor 60 may not necessarily need to be flush with the end 51b of the metal shell 50. In fact, in certain cases, it may be desirable to have the second lead 62b extend beyond the end 51b of the metal shell 50, or to have the second lead 62b extend short of the end 51b of the metal shell 50. One skilled in the art would readily understand that any configuration is possible for the second lead 62b as long as the second lead 62b can be electrically connected to the open RF signal source when the RF termination 70 mates with a connector such as the connector 30.

Referring to FIG. 3, the use of the RF termination 70 according to one embodiment of the present invention will now be discussed. As shown in FIG. 3, the RF termination 70 is mated with a conventional female connector 30 or any other type of connector to terminate or ground an open RF signal source (not shown) coupled to the connector 30. The threads 31 of the female connector 30 engage the inner surface of the metal shell 50, and the second lead 62b of the axial resistor 60 is inserted in the hole 32 of the female connector 30. This allows the second lead 62b to be electrically connected to the open RF signal source. Since one lead 62b of the axial resistor 60 is connected electrically to the open RF signal source via the connector 30 and the other lead 62a of the axial resistor 60 is grounded by being soldered or electrically connected to the metal shell 50 which is grounded by known grounding techniques, the open RF signal source will be grounded by the operation of the RF termination 70.

The shape, size, configuration, and material of the metal shell 50 as well as the resistance of the axial resistor 60 can vary depending on the application and/or the type of connector used. For example, threads corresponding with the threads 31 of the female connector 30 can be provided on the inner surface of the metal shell 50, or any other configuration can be provided thereon to facilitate the insertion and fixture of the connector within the metal shell 50.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A signal termination device for terminating an open RF signal from a communication component containing an open RF signal source, the device comprising:
a hollow shell adapted to couple with the communication component; and
an axial resistor inserted within the hollow shell and including a first lead electrically connectable to the open RF signal source and a second lead being grounded by the hollow shell.

2. The termination device of claim 1, wherein the hollow shell has two ends, one end defining a hole at in which a portion of said second lead is disposed, and the other end defining an opening configured to interface with said communication component.

3. The termination device of claim 2, wherein said opening is configured to receive a connector of said communication component.

4. The termination device of claim 3, wherein said connector is at least one of the following: a female SMA connector, a BNC connector, or a Type-N connector.

5. The termination device of claim 3, wherein a portion of the hollow shell defining the opening comprises threads.

6. The termination device of claim 2, wherein said second lead of the axial resistor is flush with one end of the hollow shell.

7. The termination device of claim 2, wherein the first lead of the axial resistor is flush with the another end of the hollow shell.

8. The termination device of claim 1, wherein the axial resistor has 50 ohm resistance.

9. The termination device of claim 1, wherein the hollow shell is integrally-formed of a conductive material and contains the entire axial resistor.

10. A method of producing a signal termination device for terminating an open RF signal from a communication component containing an open RF signal source, the method comprising the steps of:
providing a hollow shell having two ends and an axial resistor having first and second leads, said hollow shell being grounded; and
assembling the axial resistor within the hollow shell, wherein the second lead of the axial resistor is electrically connected to the hollow shell and the first lead is positioned at one end of the hollow shell to facilitate connection to the RF signal source when said RF termination device is coupled with said communication component.

11. The method of claim 10, wherein the hollow shell includes a hole at one end and an opening on the opposite end configured to interface with said communication component, and wherein the assembling step includes:
inserting the second lead of the axial resistor in the hole of the hollow shell, trimming the second lead of the axial resistor to be flush with one end of the hollow shell, and
fixedly positioning the second lead in the hole of the hollow shell so that it forms an electrical connection with said hollow shell.

12. The method of claim 11, wherein the second lead of the axial resistor is soldered within the hole of the hollow shell.

13. The method of claim 11, wherein the assembling step further includes:
trimming the first lead of the axial resistor to be flush with another end of the hollow shell.

14. A method of terminating an open RF signal source using an RF termination device, the method comprising the steps of:
providing the RF termination device including a hollow shell and an axial resistor inserted within the hollow shell, the axial resistor including a first lead connectable to the open RF signal source and a second lead being electrically connected to the hollow shell being grounded; and
engaging a connector of the open RF signal source with the RF termination device to terminate the open RF signal source.

15. The method of claim 14, wherein the hollow shell has two ends one of which defines a hole in which a portion of said second lead is disposed, and the other of which defines an opening configured to receive the connector of said open RF signal source.

16. The method of claim 15, wherein the connector is one of the following: a female SMA connector, a BNC connector, or a Type-N connector.

17. A communication component comprising:
an RF signal source;
a connector coupled with the RF signal source; and
an RF termination device comprising at least:
a hollow shell coupled with said connector and being grounded; and
an axial resistor inserted within the hollow shell and including a first lead electrically connect to the RF signal source and a second lead electrically connected to the hollow shell.

18. The communication component of claim 17, wherein said connector is one of the following: a female SMA connector, a BNC connector, or a Type-N connector.

19. The communication component of claim 17, wherein the hollow shell is made of a conductive material.

20. The communication component of claim 17, wherein the hollow shell has a cylindrical configuration having a conically tapering portion.
